(19) United States
(12) Patent Application Publication
(10) Pub. No.: US 2016/0348750 A1
(43) Pub. Date: Dec. 1, 2016

(54) BASE ISOLATOR

(71) Applicant: KABUSHIKI KAISHA TOSHIBA, Minato-ku (JP)

(72) Inventors: Gaku NAKAMURA, Yokohama (JP); Hiroshi Niwa, Nerima (JP); Tomokazu Higuchi, Yokohama (JP)

(73) Assignee: KABUSHIKI KAISHA TOSHIBA, Minato-Ku (JP)

(21) Appl. No.: 15/234,383

(22) Filed: Aug. 11, 2016

Related U.S. Application Data
(63) Continuation of application No. PCT/JP2015/056937, filed on Mar. 10, 2015.

(30) Foreign Application Priority Data
Mar. 11, 2014 (JP) 2014-047818

(51) Int. Cl. F16F 15/04; E04H 9/02

(52) U.S. Cl. CPC F16F 15/04; E04H 9/021

(57) ABSTRACT

A base isolator according to an embodiment is provided between an object to be base-isolated and a foundation, and has an elastic body expanding and contracting to reduce horizontal vibrations generated in the object. The base isolator includes: an anchored portion anchored to the foundation; a base-isolation unit having the elastic body and provided on the anchored portion; a first anchoring groove provided on a first surface which is a surface of the base-isolation unit facing the anchored portion; a second anchoring groove provided on a second surface which is a surface of the anchored portion facing the base-isolation unit. An anchor simultaneously fits into the first and second anchoring grooves such that a horizontal movement of the base-isolation unit with respect to the foundation is restricted. The anchor removes restriction on the horizontal movement of the base-isolation unit when a predetermined force is applied in a horizontal direction.

### CROSS-REFERENCE TO RELATED APPLICATIONS

This application is a continuation of International Application No. PCT/JP2015/056937, filed on Mar. 10, 2015 based upon and claims the benefit of priority from Japanese Patent Application No. 2014-047818, filed Mar. 11, 2014; the entire contents of which are incorporated herein by reference.

### FIELD

Embodiments described herein relate to a base isolator.

### BACKGROUND

A base isolator is provided to cushion the impact of an earthquake on an apparatus or a building and to reduce damage to the apparatus or the building. Cushioning of the impact of the earthquake is referred to as base isolation, and a base-isolated apparatus or building is referred to as an object to be base-isolated.

For example, the base isolator is provided between the object to be base-isolated such as the apparatus and the building and a foundation on which the object to be base-isolated is placed.

The base isolator converts strong vibrations of an earthquake generated at short intervals into mild vibrations generated at long intervals, and promptly stops the converted mild vibrations. An elastic body such as a spring and laminated rubber is included as a part of a configuration therefor. The elastic body provided in the base isolator has a function of reducing horizontal vibrations generated in the object to be base-isolated through expansion and contraction of the elastic body.

An elastic body provided in a base isolator is designed on the assumption of a load applied to the elastic body to bear the load. However, when an actually applied load exceeds the assumed load, there is a possibility that the elastic body may be damaged or fractured, and an object to be base-isolated may be subjected to a great impact.

### BRIEF DESCRIPTION OF DRAWINGS

FIG. 1A is a top plan view of a base isolator.

FIG. 1B is a cross-sectional view of the base isolator.

FIG. 2 is a layout view of the base isolator.

FIG. 3 is a cross-sectional view of an elastic body protective structure of the base isolator according to a first embodiment.

FIG. 4A is a schematic view illustrating an aspect of an operation of the elastic body protective structure of the base isolator according to the first embodiment.

FIG. 4B is a schematic view illustrating an aspect of an operation of the elastic body protective structure of the base isolator according to the first embodiment.

FIG. 5 is a cross-sectional view of an elastic body protective structure of the base isolator according to a second embodiment.

FIG. 6A is a schematic view illustrating an aspect of an operation of the elastic body protective structure of the base isolator according to the second embodiment.

FIG. 6B is a schematic view illustrating an aspect of an operation of the elastic body protective structure of the base isolator according to the second embodiment.

FIG. 7 is a cross-sectional view of an elastic body protective structure of the base isolator according to a third embodiment.

FIG. 8A is a schematic view illustrating an aspect of an operation of the elastic body protective structure of the base isolator according to the third embodiment.

FIG. 8B is a schematic view illustrating an aspect of an operation of the elastic body protective structure of the base isolator according to the third embodiment.

FIG. 8C is a schematic view illustrating an aspect of an operation of the elastic body protective structure of the base isolator according to the third embodiment.

FIG. 9 is a cross-sectional view of an elastic body protective structure of the base isolator according to a fourth embodiment.

FIG. 10 is a schematic view illustrating an aspect of an operation of the elastic body protective structure of the base isolator according to the fourth embodiment.

FIG. 11 is a cross-sectional view of an elastic body protective structure of the base isolator according to a fifth embodiment.

FIG. 12 is a schematic view illustrating an aspect of an operation of the elastic body protective structure of the base isolator according to the fifth embodiment.

FIG. 13A is a partial cross-sectional view of the elastic body protective structure of the base isolator according to the fifth embodiment.

FIG. 13B is a partial cross-sectional view of the elastic body protective structure of the base isolator according to the fifth embodiment.

### DETAILED DESCRIPTION

In order to achieve the above issue, a base isolator according to an embodiment is a base isolator which is provided between an object to be base-isolated and a foundation and which has an elastic body that expands and contracts to reduce horizontal vibrations generated in the object to be base-isolated. The base isolator includes an anchored portion that is anchored to the foundation, a base-isolation unit that is provided on the anchored portion and has the elastic body, a first anchoring groove that is provided in on first surface which is a surface of the base-isolation unit facing the anchored portion, and a second anchoring groove that is provided on a second surface which is a surface of the anchored portion facing the base-isolation unit. An anchor is simultaneously fitted into the first anchoring groove and the second anchoring groove such that a horizontal movement of the base-isolation unit with respect to the foundation is restricted. The anchor removes restrictions on the horizontal movement of the base-isolation unit when a predetermined force is applied in a horizontal direction.

Hereafter, embodiments of the invention will be described with reference to drawings.

### First Embodiment

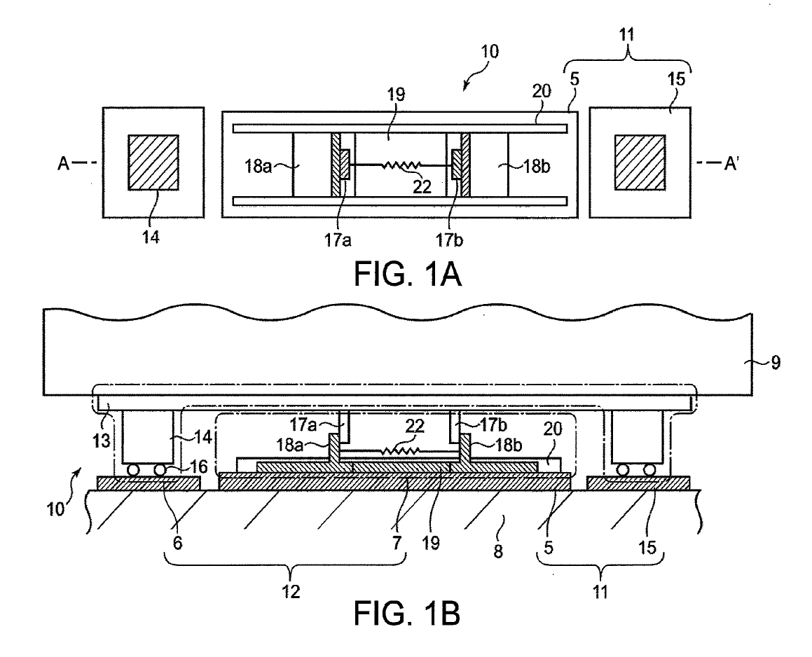

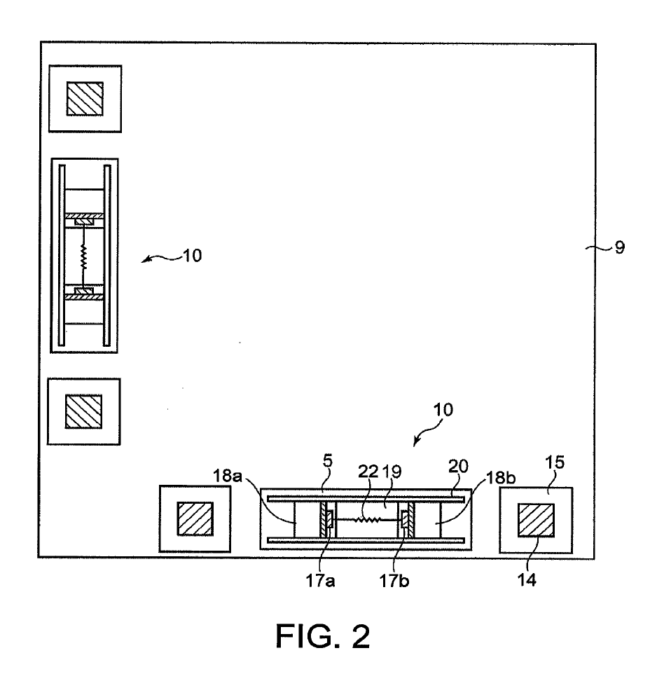

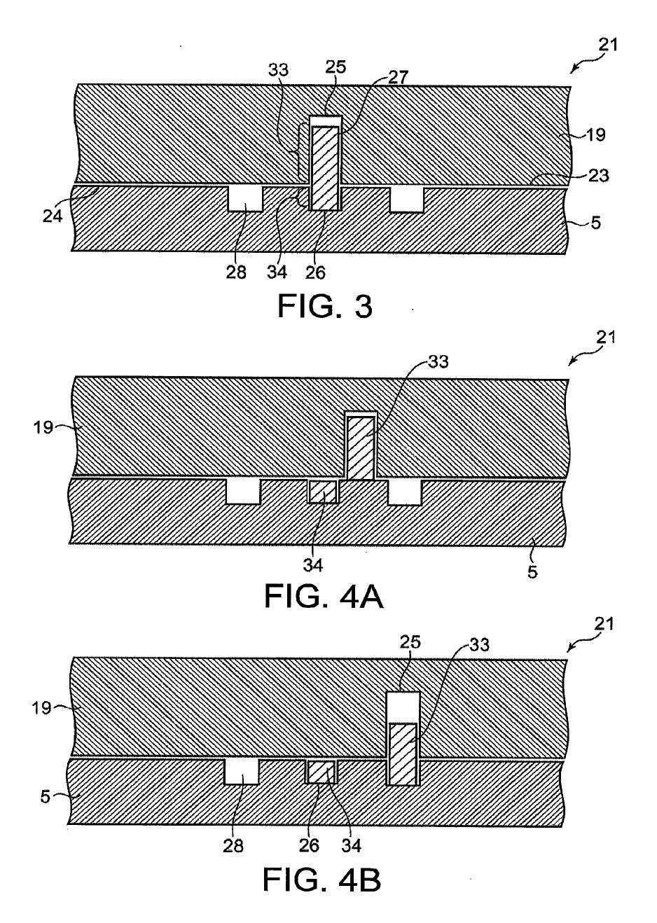

A description will be given of a protective structure of a base isolator of a first embodiment using FIGS. 1A to 4B. FIG. 1A is a top plan view of the base isolator, and FIG. 1B is a cross-sectional view of the base isolator. FIG. 2 is a layout view of the base isolator. FIG. 3 is a cross-sectional view of an elastic body protective structure of the base isolator according to a first embodiment. FIGS. 4A and 4B are schematic views illustrating an aspect of an operation of the elastic body protective structure of the base isolator according to the first embodiment. An apparatus, a building and the like provided with the base isolator is referred to as an object to be base-isolated. In addition, in the present embodiment, the object to be base-isolated is regarded as the apparatus.

(Configuration)

In the present embodiment, an object to be base-isolated 9 is in a building and is provided on a foundation 8 which is provided on a floor of the building, and a base isolator 10 is provided between the object to be base-isolated 9 and the foundation 8. The foundation 8 may be integrated with the floor of the building. Alternatively, when the object to be base-isolated 9 is provided on a first floor of the building or outside the building, the foundation 8 may be a ground and be directly fixed to the ground.

FIGS. 1A and 1B are schematic views of the base isolator 10, and a cross-sectional view taken along line AA′ of the top plan view illustrated in FIG. 1A corresponds to FIG. 1B. In addition, in the cross-sectional view illustrated in FIG. 1B, a top plan view of a configuration below the object to be base-isolated 9 corresponds to FIG. 1A.

The base isolator 10 includes an anchored portion 11 anchored to the foundation 8 and a base-isolation unit 12 provided on the anchored portion 11. The anchored portion 11 has a configuration such that the anchored portion 11 is anchored to the foundation 8, and includes a slide plate 15 and an anchored plate 5. The base-isolation unit 12 includes a rolling unit 6 which is provided on the slide plate 15 to cushion an impact of an earthquake, and a damping unit 7 which is provided on the anchored plate 5 to reduce horizontal vibrations generated in the object to be base-isolated 9.

The rolling unit 6 includes a base-isolation stand 13 on which the object to be base-isolated 9 is placed and fixed thereto, a base-isolation stand supporting leg 14 which supports the base-isolation stand 13, and a roller 16 provided between the slide plate 15 and the base-isolation stand supporting leg 14. The slide plate 15 is provided to be directly under the base-isolation stand supporting leg 14. Friction of the roller 16 with the slide plate 15 and the base-isolation stand supporting leg 14 is presumed to be small.

In addition, the roller 16 is provided between the base-isolation stand supporting leg 14 and the slide plate 15, and thus the base-isolation stand supporting leg 14, the base-isolation stand 13, and the object to be base-isolated 9 may move on the slide plate 15. A guide member 20 is provided such that the base-isolation stand supporting leg 14 moves on an axis in one direction. The base-isolation stand supporting leg 14 moves along the guide member 20 which is provided in the anchored portion 11 or the foundation 8. The guide member 20 has a linear shape, and thus the base-isolation stand 13 moves on a straight line.

The damping unit 7 includes two engaging members 17a and 17b which protrude from the base-isolation stand 13 in a vertically downward direction, two sliding engagement members 18a and 18b provided on the anchored plate 5, and a sliding engagement member control part 19 provided on the anchored plate 5. The two engaging members 17a and 17b are disposed side by side in a direction of a straight line on which the base-isolation stand 13 may move. In addition, the sliding engagement members 18a and 18b and the sliding engagement member control part 19 are disposed side by side in an order of the sliding engagement member 18a, the sliding engagement member control part 19, and the sliding engagement member 18b in the direction of the straight line on which the base-isolation stand 13 may move.

The sliding engagement members 18a and 18b protrude in a vertically upward direction, the two sliding engagement members 18a and 18b are provided to insert the two engaging members 17a and 17b therebetween from the outside, and the sliding engagement members 18a and 18b interpose the engaging members 17a and 17b, respectively. In addition, the sliding engagement members 18a and 18b are connected to a horizontal spring 22 corresponding to an elastic body. The horizontal spring 22 is a spring that expands and contracts in a horizontal direction. The sliding engagement members 18a and 18b is movable in the horizontal direction along the guide member 20 on the anchored plate 5.

The sliding engagement member control part 19 is provided between the two sliding engagement members 18a and 18b, and horizontal movement thereof is fixed by the elastic body protective structure 21 on the anchored plate 5. The elastic body protective structure 21 is a structure provided between the anchored plate 5 and the sliding engagement member control part 19.

Next, the elastic body protective structure 21 will be described using FIG. 3. First, a surface that faces the anchored plate 5 of the sliding engagement member control part 19 which is a portion of a configuration of the base-isolation unit 12 is referred to as a first surface 23. In addition, a surface of the anchored plate 5 facing the sliding engagement member control part 19 is referred to as a second surface 24. In other words, in the anchored plate 5 of FIG. 2, an upper end plane corresponds to the second surface 24. The first surface 23 and the second surface 24 come into contact with each other.

The elastic body protective structure 21 includes a first anchoring groove 25 provided on the first surface 23 of the sliding engagement member control part 19, a second anchoring groove 26 provided on the second surface 24, and an anchor 27 fitted into the first anchoring groove 25 and the second anchoring groove 26.

Herein, a portion of the anchor 27 fitted or having been fitted into the first anchoring groove 25 is referred to as a first anchoring groove fitted portion 33. In addition, a portion of the anchor 27 fitted or having been fitted into the second anchoring groove 26 is referred to as a second anchoring groove fitted portion 34.

Further, in addition to the second anchoring groove 26, a re-anchoring groove 28 is provided on the second surface 24. The first anchoring groove fitted portion 33 may be fitted into the re-anchoring groove 28. For example, as illustrated in FIG. 3, it is presumed that the re-anchoring groove 28 is provided on each of left and right sides of the second anchoring groove 26. A vertical length of the first anchoring groove fitted portion 33 is longer than a vertical depth of the re-anchoring groove 28. In addition, a vertical depth of the first anchoring groove 25 is greater than the vertical depth of the re-anchoring groove 28.

(Operation)

Hereinafter, a description will be given of an operation of the base isolator of the present embodiment. First, an operation of the rolling unit 6 will be described. Friction between the slide plate 15 and the roller 16 and friction between the roller 16 and the base-isolation stand supporting leg 14 are small. Thus, even when a horizontal position of the foundation 8 is changed due to an earthquake, a horizontal force is rarely applied to the base-isolation stand 13, and the base-isolation stand 13 does not move. In other words, when the base-isolation unit 12 is provided to be movable with respect to the anchored portion 11, the rolling unit 6 may cushion an impact of the earthquake on the object to be base-isolated 9. When the foundation 8 moves, the base-isolation stand 13 relatively moves on the foundation 8.

Next, an operation of the damping unit 7 will be described. The damping unit 7 has a function of reducing horizontal vibrations generated in the object to be base-isolated 9 and the base-isolation unit 7.

For example, referring to FIG. 1B, when the base-isolation stand 13 relatively moves rightward with respect to the foundation 8 in response to movement of the foundation 8, the engaging members 17a and 17b move rightward, and the sliding engagement member 18b interposing the engaging member 17b also moves rightward. On the other hand, the sliding engagement member 18a does not move since rightward movement thereof is restricted by the sliding engagement member control part 19. In addition, the horizontal spring 22 connected to the sliding engagement member 18a and the sliding engagement member 18b is stretched, a leftward force is applied to the sliding engagement member 18b and the engaging member 17b due to an elastic force thereof, and rightward movement of the base-isolation stand 13 is suppressed.

In addition, referring to FIG. 1B, when the base-isolation stand 13 relatively moves leftward with respect to the foundation 8 in response to movement of the foundation 8, the engaging members 17a and 17b move leftward, and the sliding engagement member 18a interposing the engaging member 17a also moves leftward. On the other hand, the sliding engagement member 18b does not move since leftward movement thereof is restricted by the sliding engagement member control part 19. In addition, the horizontal spring 22 connected to the sliding engagement member 18a and the sliding engagement member 18b is stretched, a rightward force is applied to the sliding engagement member 18a and the engaging member 17a due to an elastic force thereof, and leftward movement of the base-isolation stand 13 is suppressed.

As described in the foregoing, a force is applied to the base-isolation stand 13 in an opposite direction with respect to a direction of movement due to the elastic force of the horizontal spring 22, and thus the damping unit 7 promptly attenuates horizontal vibrations with respect to the anchored portion 11 generated in the base-isolation unit 12.

The base-isolation unit 12 moves on the anchored plate 5 and the foundation 8 within a range in which the horizontal spring 22 expands and contracts around a position at which the sliding engagement member control part 19 is fixed to the anchored plate 5. In addition, the sliding engagement member control part 19 is fixed to the foundation 8 by the elastic body protective structure 21. In other words, it is possible to presume that horizontal movement of the base-isolation unit 12 is restricted by the elastic body protective structure 21.

Further, the base isolator of the present embodiment may allow base isolation on an axis in one horizontal direction when one base isolator is used. As illustrated in FIG. 2, when two base isolators are provided to be perpendicular to one object to be base-isolated on a horizontal plane, base isolation may be allowed with respect to vibrations in more directions in the horizontal direction.

Furthermore, the horizontal spring 22 may withstand a force intended to stretch the horizontal spring 22 and may contract. However, when a force for stretching the horizontal spring 22 exceeds a predetermined value, the horizontal spring 22 may be damaged or fractured. Here, the force applied to the horizontal spring 22 in a stretching direction is referred to as a stretching force.

Next, an operation of the elastic body protective structure 21 will be described. The elastic body protective tool 21 is a structure for protecting the horizontal spring 22 such that the horizontal spring 22 is not damaged. When the base-isolation stand 13 moves with respect to the foundation 8 and the anchored portion 11, and the horizontal spring 22 is stretched, a force, which is equivalent to the stretching force applied to the horizontal spring 22, is applied to the anchor 27. For example, referring to FIG. 3, when the base-isolation stand 13 moves rightward, a rightward stretching force is applied to the horizontal spring 22, and a force equivalent to the stretching force is also applied to the first anchoring groove fitted portion 33 from a right side.

The anchor 27 is configured to be weaker than the horizontal spring 22 with respect to the stretching force. In other words, it is presumed that the anchor 27 is designed such that, when the same stretching force is applied to the horizontal spring 22 and the anchor 27, the anchor 27 is fractured before the horizontal spring 22 is damaged. Then, the portion fitted into the first anchoring groove 25 and the portion fitted into the second anchoring groove 26 are fractured in the anchor 27. For example, it is presumed that the anchor 27 has a notch which is cut at a boundary between the first anchoring groove fitted portion 33 and the second anchoring groove fitted portion 34.

The anchor 27 is presumed to be fractured when the stretching force applied to the anchor 27 reaches an anchor breaking force. The anchor breaking force is a force smaller than a stretching force at which the horizontal spring 22 is damaged.

When the anchor 27 is fractured, fixing of the sliding engagement member control part 19 to the anchored plate 5 is released, and the stretching force applied to the horizontal spring 22 is mitigated. For example, when the base-isolation stand 13 moves rightward, and the stretching force exceeds the anchor breaking force, the anchor 27 is fractured, the sliding engagement member control part 19 and the sliding engagement member 18a move rightward, and the stretching force applied to the horizontal spring 22 is mitigated.

After mitigating the stretching force applied to the horizontal spring 22, the elastic body protective structure 21 may fix the sliding engagement member control part 19 to the anchored plate 5 again. Then, the horizontal spring 22 may attenuate horizontal vibrations again.

For example, when the anchor 27 is fractured and the sliding engagement member control part 19 moves rightward, the first anchoring groove fitted portion 33 is left in the first anchoring groove 25 as illustrated in FIG. 4A, and moves together with the sliding engagement member control part 19. Then, when the first anchoring groove 25 reaches a position immediately above the re-anchoring groove 28, the first anchoring groove fitted portion 33 falls into the re-anchoring groove 28 and is fitted into the re-anchoring groove 28 as illustrated in FIG. 4B. The depth of the re-anchoring groove 28 is smaller than the vertical length of the first anchoring groove fitted portion 33. For this reason, the first anchoring groove fitted portion 33 is fitted into the first anchoring groove 25 and the re-anchoring groove 28, and a horizontal position of the sliding engagement member control part 19 is fixed to the anchored plate 5 again.

Then, when the sliding engagement member control part 19 is fixed to the anchored plate 5, the horizontal spring 22 may expand and contract again in response to movement of the base-isolation stand 13 and may attenuate vibrations of the base-isolation stand 13.

The above description is similarly applied to a case in which the base-isolation stand 13 moves leftward and the anchor 27 is fractured. When the anchor 27 is fractured, a leftward stretching force of the horizontal spring 22 is mitigated. Further, when the first anchoring groove fitted portion 33 is fitted into the first anchoring groove 25 and the re-anchoring groove 28, the sliding engagement member control part 19 is fixed to the anchored portion 11 again.

(Effect)

Hereinafter, a description will be given of an effect of the base isolator 10 of the present embodiment. In the base isolator 10 of the present embodiment, the anchor 27, which anchors the base isolator 10 and the foundation 8, is fractured before the horizontal spring 22 is damaged or fractured. Then, fixing between the base-isolation unit 12 and the anchored plate 5, that is, the foundation 8 is released, and the stretching force applied to the horizontal spring 22 is mitigated. For this reason, even when an impact, which fractures the horizontal spring 22, is applied to the base isolator 10, the horizontal spring 22 may be prevented from being damaged.

In addition, the base isolator 10 has the re-anchoring groove 28 which is shallower than the first anchoring groove fitted portion 33. Thus, after fixing between the base isolator 10 and the foundation 8 is released, the base isolator 10 may be fixed to the foundation 8 again. For this reason, even when an excessive impact is applied to the base isolator, the horizontal spring 22 may attenuate vibrations of the base-isolation stand 13 and the object to be base-isolated 9 again. Further, even when an impact of an earthquake greater than expected occurs, the object to be base-isolated 9 may be base-isolated.

### Second Embodiment

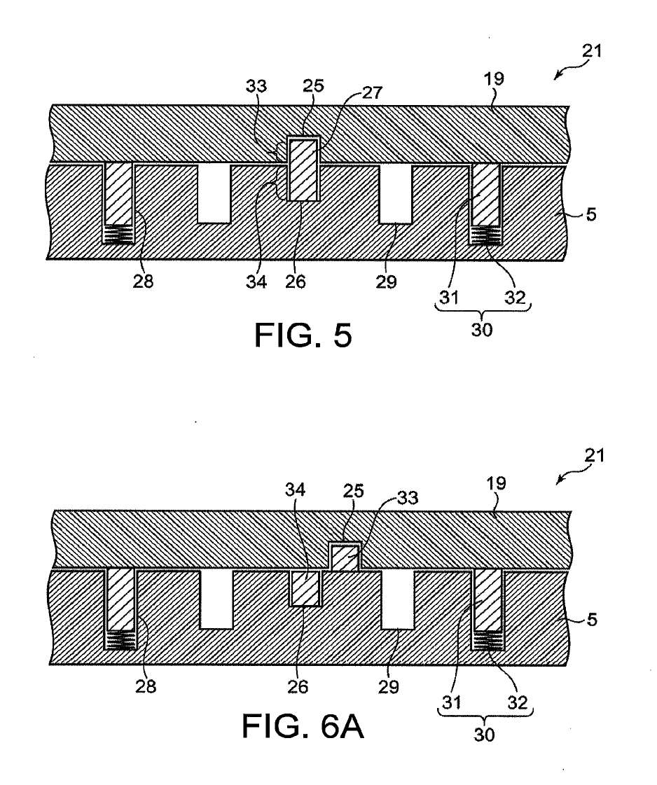

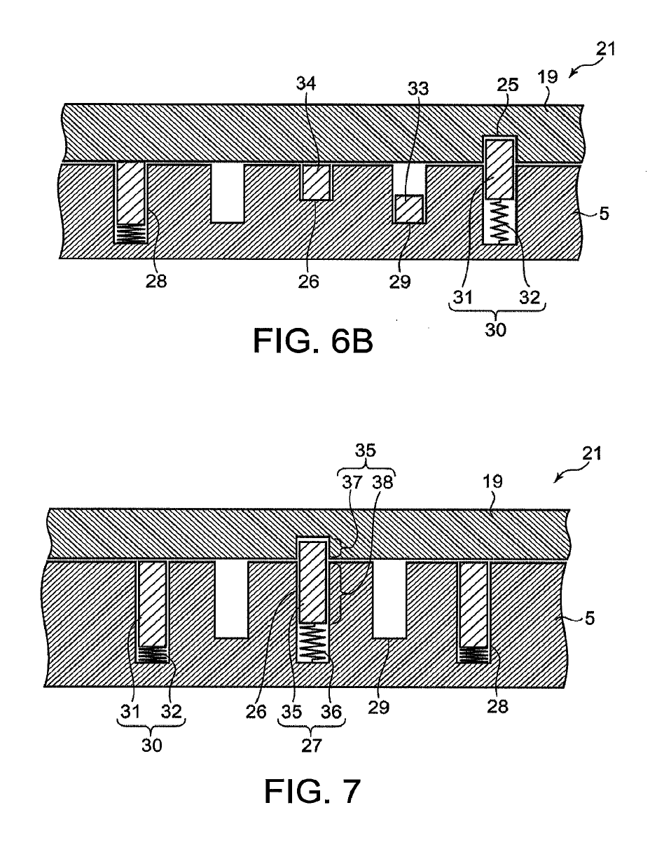

Next, a second embodiment will be described using FIGS. 5 to 6B. FIG. 5 is a cross-sectional view of an elastic body protective structure of a base isolator according to the second embodiment. FIGS. 6A and 6B are schematic views illustrating an aspect of an operation of the elastic body protective structure of the base isolator according to the second embodiment. The same reference numeral is applied to the same component as that of the first embodiment, and repeated description will not be presented.

(Configuration)

As illustrated in FIG. 5, an elastic body protective structure 21 of a base isolator 10 of the present embodiment includes a fractured object falling groove 29 provided on a second surface 24 in addition to the configuration of the first embodiment. The fractured object falling groove 29 is provided between a second anchoring groove 26 and a re-anchoring groove 28. In addition, a vertical depth of the re-anchoring groove 28 is greater than a vertical length of a first anchoring groove fitted portion 33.

A re-anchor 30 is provided inside the re-anchoring groove 28 of the present embodiment. The re-anchor 30 may be stored so as not to extrude from the re-anchoring groove 28. The re-anchor 30 includes a re-fitted portion 31, which can be fitted into a first anchoring groove 25, and a re-anchor pushing-up portion 32.

The re-fitted portion 31 has a shape of a vertically long rod, and a vertically upward force is applied thereto by the re-anchor pushing-up portion 32. In addition, a vertical length of the re-fitted portion 31 is greater than a vertical depth of the first anchoring groove 25.

For example, the re-anchor pushing-up portion 32 is presumed to be a spring. However, the re-anchor pushing-up portion 32 may have a configuration other than the spring when the re-anchor pushing-up portion 32 can apply the vertically upward force to the re-fitted portion 31. In addition, when an anchor 27 is fitted into the second anchoring groove 26, openings of the fractured object falling groove 29 and the re-anchoring groove 28 are closed by a first surface 23 of a base-isolation unit 12

(Operation)

A description will be given of an operation of the elastic body protective structure 21 of the present embodiment. Similarly to the first embodiment, a base-isolation stand 13 moves with respect to an anchored plate 5, and the anchor 27 is fractured when a force applied to the anchor 27 reaches an anchor breaking force. Further, as illustrated in FIG. 6A, a sliding engagement member control part 19 moves in a direction in which a horizontal spring 22 is stretched, and a stretching force of the horizontal spring 22 is mitigated. In FIG. 6A, the sliding engagement member control part 19 moves rightward. Then, the first anchoring groove fitted portion 33 moves together with the sliding engagement member control part 19.

As illustrated in FIG. 6B, when the first anchoring groove 25 reaches a position immediately above the fractured object falling groove 29 due to movement of the sliding engagement member control part 19, the first anchoring groove fitted portion 33 falls into the fractured object falling groove 29. A vertical depth of the fractured object falling groove 29 is greater than a vertical length of the first anchoring groove fitted portion 33. For this reason, the sliding engagement member control part 19 is not fixed to the fractured object falling groove 29. An inside of the first anchoring groove 25 becomes empty.

Furthermore, when the sliding engagement member control part 19 moves, and the first anchoring groove 25 reaches a position immediately above the re-anchoring groove 28, the re-fitted portion 31 of the re-anchor 30 is pushed up from the re-anchoring groove 28 by a pushing-up portion 32 and is fitted into the first anchoring groove 25. A vertical length of the re-fitted portion 31 is greater than the vertical depth of the first anchoring groove 25. Thus, the re-fitted portion 31 is fitted into the first anchoring groove 25 and the re-anchoring groove 28, and a horizontal position of the sliding engagement member control part 19 is fixed to the anchored plate 5 again. Then, when the sliding engagement member control part 19 is fixed to the anchored plate 5, the horizontal spring 22 may expand and contract in response to movement of the base-isolation stand 13 again, and rightward and leftward vibrations of the base-isolation stand 13 with respect to an anchored portion 11 may be attenuated.

(Effect)

Hereinafter, a description will be given of an effect of the base isolator 10 of the present embodiment. Similarly to the first embodiment, when the anchor 27, which fixes the base isolator 10 to the foundation 8, is fractured, the base isolator 10 of the present embodiment mitigates a tensile force applied to the horizontal spring 22. For this reason, even when an impact is applied to the base isolator 10, the horizontal spring 22 is not damaged.

In addition, similarly to the first embodiment, the base isolator 10 includes the re-anchoring groove 28, and thus the base isolator 10 may be fixed to the foundation 8 again after fixing between the base isolator 10 and the foundation 8 is released. For this reason, even when an impact greater than expected is applied to the base isolator, the horizontal spring 22 may attenuate vibrations of the base-isolation stand 13 and an object to be base-isolated 9 again. Further, even when an impact greater than expected occurs, the object to be base-isolated 9 may be base-isolated.

In addition, in the present embodiment, the re-fitted portion 31 pushed up from a side of the anchored plate 5 is fitted into the first anchoring groove 25 and the re-anchoring groove 28, and the sliding engagement member control part 19 is fixed to the anchored plate 5 again. For this reason, the vertical length of the first anchoring groove fitted portion 33 may be made shorter in the present embodiment when compared to the first embodiment. Further, the first anchoring groove 25 may be made shallower than that of the first embodiment by the shortened vertical length of the first anchoring fitting portion 33.

For this reason, the elastic body protective structure 21 of the present embodiment may be provided even when the sliding engagement member control part 19 has insufficient thickness.

### Third Embodiment

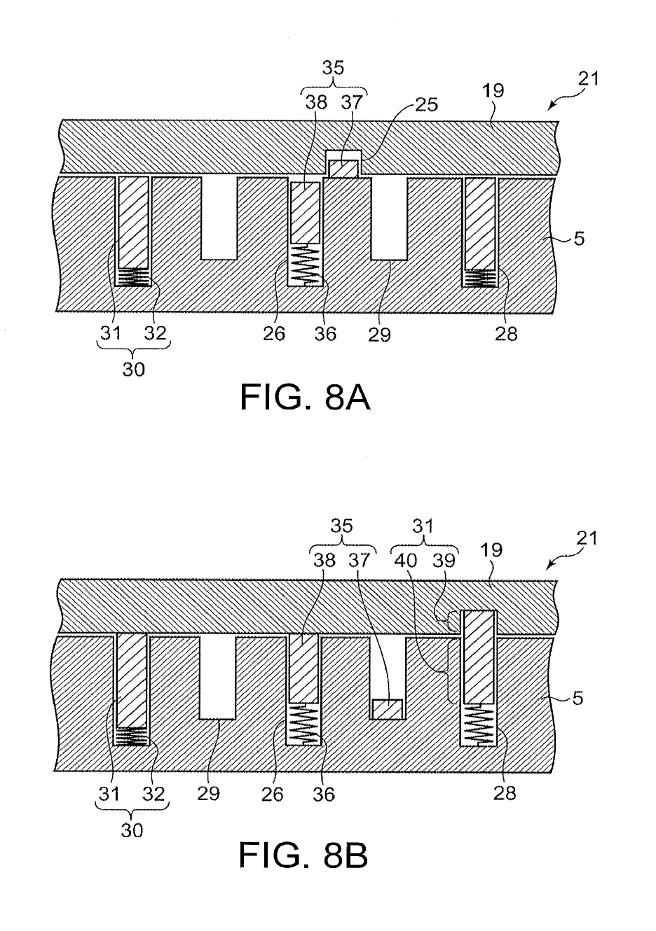

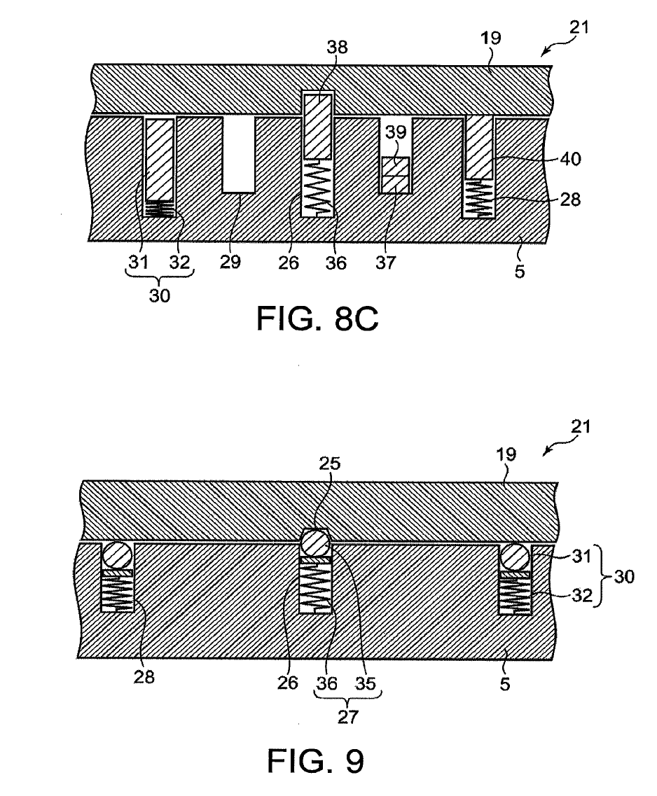

Next, a description will be given of a third embodiment using FIGS. 7 to 8C. FIG. 7 is a cross-sectional view of an elastic body protective structure of a base isolator according to the third embodiment. FIGS. 8A to 8C are schematic views illustrating aspects of operations of the elastic body protective structure of the base isolator according to the third embodiment. The same reference numeral is applied to the same component as that of the first embodiment or the second embodiment, and repeated description will not be presented.

(Configuration)

As illustrated in FIG. 7, referring to an elastic body protective structure 21 of a base isolator 10 of the present embodiment, in addition to the configuration of the second embodiment, an anchor 27 includes a fitted portion 35 and an anchor pushing-up portion 36. The fitted portion 35 may be fitted into a first anchoring groove 25, and a vertical length thereof is greater than a vertical depth of the first anchoring groove 25. The anchor pushing-up portion 36 is provided inside a second anchoring groove 26, and applies a vertically upward force to the fitted portion 35. For example, the anchor pushing-up portion 36 is presumed to be a spring. However, the anchor pushing-up portion 36 may have a configuration other than the spring when the anchor pushing-up portion 36 can apply the vertically upward force to the fitted portion 35.

Herein, a portion of the fitted portion 35 fitted into the first anchoring groove 25 or a portion of the fitted portion 35 having been fitted into the first anchoring groove 25 is referred to as a third anchoring groove fitted portion 37. In addition, a portion of the fitted portion 35 fitted into the second anchoring groove 26 or a portion of the fitted portion 35 having been fitted into the second anchoring groove 26 is referred to as a fourth anchoring groove fitted portion 38.

Further, a portion of a re-fitted portion 31 fitted or having been fitted into the first anchoring groove 25 is referred to as a fifth anchoring groove fitted portion 39. In addition, when the re-fitted portion 31 is fitted into the first anchoring groove 25, a portion of the re-fitted portion 31 fitted into a re-anchoring groove 28 is referred to as a sixth anchoring groove fitted portion 40.

Furthermore, it is presumed that a vertical depth of a fractured object falling groove 29 is greater than a vertical length of each of the third anchoring groove fitted portion 37 and the fifth anchoring groove fitted portion 39 by several times. In addition, both the fitted portion 35 and the re-fitted portion 31 are designed to be fractured when an anchor breaking force is applied.

(Operation)

A description will be given of an operation of the elastic body protective structure 21 of the present embodiment. As illustrated in FIG. 8A, when a base-isolation stand 13 moves with respect to an anchored plate 5 and a force applied to the fitted portion 35 becomes the anchor breaking force, the fitted portion 35 is fractured. Then, a sliding engagement member control part 19 moves in a direction in which a horizontal spring 22 is stretched, and a stretching force of the horizontal spring 22 is mitigated. The third anchoring groove fitted portion 37 also moves together with the sliding engagement member control part 19.

As illustrated in FIG. 8B, when the first anchoring groove 25 reaches a position immediately above the fractured object falling groove 29 due to rightward movement of the sliding engagement member control part 19, the third anchoring groove fitted portion 37 falls into the fractured object falling groove 29. The vertical depth of the fractured object falling groove 29 is greater than the vertical length of the third anchoring groove fitted portion 37. For this reason, the sliding engagement member control part 19 is not fixed to the fractured object falling groove 29. An inside of the first anchoring groove 25 becomes empty.

When the sliding engagement member control part 19 further moves and the first anchoring groove 25 reaches a position immediately above the re-anchoring groove 28, the re-fitted portion 31 is fitted into the first anchoring groove 25 similarly to the second embodiment. Then, a horizontal position of the sliding engagement member control part 19 is fixed to the anchored plate 5 again, and the horizontal spring 22 may attenuate rightward and leftward vibrations of the base-isolation stand 13 with respect to an anchored portion 11 again.

After the re-fitted portion 31 is fitted into the first anchoring groove 25, it is presumed that the base-isolation stand 13 moves leftward again due to an earthquake and the like, and the anchor breaking force is applied to the re-fitted portion 31. Then, the re-fitted portion 31 is fractured into the fifth anchoring groove fitted portion 39 and the sixth anchoring groove fitted portion 40, and the sliding engagement member control part 19 moves leftward.

As illustrated in FIG. 8C, when the first anchoring groove 25 reaches a position immediately above the fractured object falling groove 29 due to leftward movement of the sliding engagement member control part 19, the fifth anchoring groove fitted portion 39 falls into the fractured object falling groove 29. The vertical depth of the fractured object falling groove 29 is several times greater than the vertical length of each of the third anchoring groove fitted portion 37 and the fifth anchoring groove fitted portion 39. For this reason, even though the third anchoring groove fitted portion 37 previously falls into the fractured object falling groove 29, the sliding engagement member control part 19 is not fixed to the fractured object falling groove 29.

When the sliding engagement member control part 19 further moves leftward and the first anchoring groove 25 reaches a position immediately above the second anchoring groove 26, the fourth anchoring groove fitted portion 38 pushed up by the fitted portion pushing-up portion 36 is fitted into the first anchoring groove 25. Then, a horizontal position of the sliding engagement member control part 19 is fixed to the anchored plate 5 again, and the horizontal spring 22 may attenuate rightward and leftward vibrations of the base-isolation stand 13 with respect to an anchored portion 11 again.

(Effect)

Hereinafter, a description will be given of an effect of the base isolator 10 of the present embodiment. Similarly to the first embodiment, the base isolator 10 of the present embodiment mitigates a tensile force applied to the horizontal spring 22 when the anchor 27, which fixes the base isolator 10 to a foundation 8, is fractured. For this reason, even when an impact is applied to the base isolator 10, the horizontal spring 22 is not damaged.

In addition, similarly to the first embodiment, the base isolator 10 includes the re-anchoring groove 28, and thus the base isolator 10 may be fixed to the foundation 8 again after fixing between the base isolator 10 and the foundation 8 is released. For this reason, even when an impact greater than expected is applied to the base isolator, the horizontal spring 22 may attenuate vibrations of the base-isolation stand 13 and an object to be base-isolated 9 again.

In addition, similarly to the second embodiment, the first anchoring groove 25 may be made shallower than that of the first embodiment, and the elastic body protective structure 21 may be provided even when the sliding engagement member control part 19 has insufficient thickness.

Further, in the base isolator 10 of the present embodiment, the anchor 27 of the elastic body protective structure 21 includes the fitted portion 35 and the fitted portion pushing-up portion 36.

For this reason, when the first anchoring groove 25, fitting of which into the second anchoring groove 26 is released once, reaches the position immediately above the second anchoring groove 26 again, the anchor 27 may fix the sliding engagement member control part 19 to the anchored plate 5.

In the present embodiment, in more places, the sliding engagement member control part 19, fixing of which to the anchored plate 5 is released, may be fixed again. For this reason, even when an impact that reaches the anchor breaking force is applied to the elastic body protective structure 21 a plurality number of times, the horizontal spring 22 may be prevented from being damaged or ruptured. For this reason, it is possible to cope with a plurality of earthquakes and to base-isolate the object to be base-isolated 9 for a longer period of time.

### Fourth Embodiment

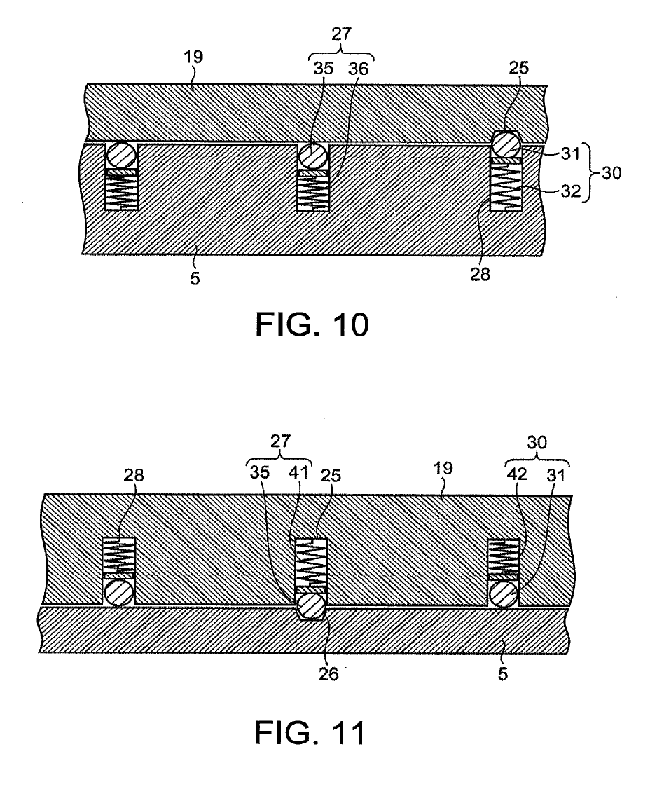

Next, a description will be given of a fourth embodiment using FIGS. 9 and 10. FIG. 9 is a cross-sectional view of an elastic body protective structure of a base isolator according to the fourth embodiment, and FIG. 10 is a schematic view illustrating an aspect of an operation of the elastic body protective structure of the base isolator according to the fourth embodiment. The same reference numeral is applied to the same component as that of the first embodiment to the third embodiment, and repeated description will not be presented.

(Configuration)

As illustrated in FIG. 9, referring to an elastic body protective structure 21 of a base isolator 10 of the present embodiment, a fitted portion 35 and a re-fitted portion 31 in the configuration of the third embodiment have spherical shapes. For example, it is presumed that an anchor 27 and a re-anchor 30 correspond to ball cylinders.

In addition, a first anchoring groove 25 of the present embodiment has a width which broadens from an bottom side portion of an opening to the opening, and a wall surface thereof is inclined.

Further, a fractured object falling groove 29 is not provided in the present embodiment.

(Operation)

A description will be given of an operation of the elastic body protective structure 21 of the present embodiment. For example, as illustrated in FIG. 10, when a base-isolation stand 13 moves rightward with respect to an anchored plate 5, the fitted portion 35 receives a force in a direction in which the fitted portion 35 is confined in a second anchoring groove 26 due to the inclined wall surface of the first anchoring groove 25. Then, when the force applied to the fitted portion 35 reaches a fitting releasing force, the fitted portion 35 is confined in the second anchoring groove 26, and fitting of the fitted portion 35 into the first anchoring groove 25 is released. Then, a sliding engagement member control part 19 moves rightward.

When the sliding engagement member control part 19 moves rightward and the first anchoring groove 25 reaches a position immediately above a re-anchoring groove 28, the re-fitted portion 31 pushed out from the re-anchoring groove 28 is fitted into the first anchoring groove 25. Then, a horizontal position of the sliding engagement member control part 19 is fixed to the anchored plate 5, and a horizontal spring 22 may attenuate rightward and leftward vibrations of the base-isolation stand 13 with respect to an anchored portion 11 again.

In addition, the elastic body protective structure 21 similarly operates even when the base-isolation stand 13 moves leftward with respect to the anchored plate 5.

An anchor pushing-up portion 36 and a re-anchor pushing-up portion 32 are designed such that fitting of the fitted portion 35 or the re-fitted portion 31 into the first anchoring groove 25 is released before the horizontal spring 22 is damaged when the base-isolation stand 13 moves with respect to the anchored plate 5. In other words, a force applied to the fitted portion 35 or the re-fitted portion 31 reaches the fitting releasing force before the horizontal spring 22 is damaged, and fitting of the fitted portion 35 or the re-fitted portion 31 into the first anchoring groove 25 is released.

(Effect)

Hereinafter, a description will be given of an effect of the base isolator 10 of the present embodiment. The elastic body protective structure 21 of the present embodiment may repeatedly fix the sliding engagement member control part 19 to the anchored plate 5 and release the fixing even when the anchor 27 and the re-anchor 30 are not fractured. For this reason, the anchor 27 and the re-anchor 30 may repeatedly release fixing of the sliding engagement member control part 19 and fix the sliding engagement member control part 19 again a number of times which is not particularly limited.

Therefore, when the base isolator 10 of the present embodiment is used, the horizontal spring 22 may be prevented from being damaged or ruptured even when a greater vibration is generated for a longer period of time.

The fitted portion 35 and the re-fitted portion 31 may not have the spherical shapes when friction with the first anchoring groove 25 and a first surface 23 is small. For example, as illustrated in FIG. 13A, it is possible to employ a cylindrical shape in which only an upper end portion is an upwardly convex spherical shape. Alternatively, as illustrated in FIG. 13B, the upper end portion of the fitted portion 35 or the re-fitted portion 31 may become thinner in a vertically upward direction and may be inclined. In this case, the wall surface of first anchoring groove 25 may not be inclined.

### Fifth Embodiment

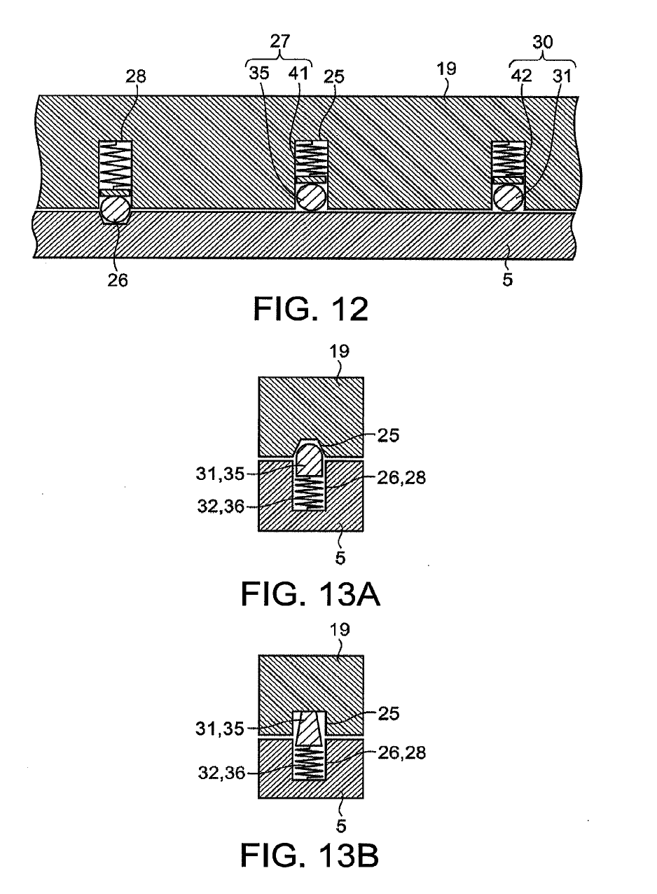

Next, a description will be given of a fifth embodiment using FIGS. 11 and 12. FIG. 11 is a cross-sectional view of an elastic body protective structure of a base isolator according to the fifth embodiment. FIG. 12 is a schematic view illustrating an aspect of an operation of the elastic body protective structure of the base isolator according to the fifth embodiment. The same reference numeral is applied to the same component as that of the first embodiment to the fourth embodiment, and repeated description will not be presented.

(Configuration)

As illustrated in FIG. 11, referring to an elastic body protective structure 21 of a base isolator 10 of the present embodiment, an anchor 27 may be stored in a first anchoring groove 25 such that the anchor 27 does not extrude from the first anchoring groove 25, and the anchor 27 includes a fitted portion 35 having a spherical shape and a fitted portion pushing-down portion 41 which applies a force to the fitted portion 35 in a vertically downward direction.

In addition, unlike the fourth embodiment, a re-anchoring groove 28 is provided on a first surface 23. A re-anchor 30 is provided inside the re-anchoring groove 28. The re-anchor 30 includes a re-fitted portion 31 having a spherical shape and a re-anchor pushing-down portion 42 which applies a force to the re-anchor 30 in the vertically downward direction. The re-anchor 30 may be stored such that the re-anchor 30 does not extrude from the re-anchoring groove 28. For example, it is presumed that the anchor 27 and the re-anchor 30 correspond to ball cylinders.

A second anchoring groove 26 has a width which broadens from an bottom side portion of an opening to the opening, and a wall surface thereof is inclined.

(Operation)

A description will be given of an operation of the elastic body protective structure 21 of the present embodiment. For example, as illustrated in FIG. 12, when a base-isolation stand 13 moves rightward with respect to an anchored plate 5 and the force applied to the fitted portion 35 becomes a fitting releasing force, the fitted portion 35 is confined in the second anchoring groove 26 due to the inclined wall surface of the second anchoring groove 26, and fitting of the fitted portion 35 into the second anchoring groove 26 is released. Then, a sliding engagement member control part 19 moves rightward.

When the sliding engagement member control part 19 moves rightward, and the re-anchoring groove 28 reaches a position immediately above the second anchoring groove 26, the re-fitted portion 31 pushed out from the re-anchoring groove 28 is fitted into the second anchoring groove 26. Then, a horizontal position of the sliding engagement member control part 19 is fixed to the anchored plate 5, and a horizontal spring 22 may attenuate rightward and leftward vibrations of the base-isolation stand 13 with respect to an anchored portion 11 again.

In addition, the elastic body protective structure 21 similarly operates when the base-isolation stand 13 moves leftward with respect to the anchored plate 5, and the fitting releasing force corresponds to a leftward direction.

Similarly to the fourth embodiment, the anchor pushing-down portion 41 and the re-anchor pushing-down portion 42 are designed such that fitting of the fitted portion 35 or the re-fitted portion 31 into the second anchoring groove 26 is released before the horizontal spring 22 is damaged when the base-isolation stand 13 moves with respect to the anchored plate 5. In other words, a force applied to the fitted portion 35 or the re-fitted portion 31 reaches the fitting releasing force before the horizontal spring 22 is damaged, and fitting of the fitted portion 35 or the re-fitted portion 31 into the second anchoring groove 26 is released.

(Effect)

Hereinafter, a description will be given of an effect of the base isolator 10 of the present embodiment. Similarly to the fourth embodiment, the elastic body protective structure 21 of the present embodiment may repeatedly fix the sliding engagement member control part 19 to the anchored plate 5 and release the fixing even when the anchor 27 and the re-anchor 30 are not fractured. For this reason, the anchor 27 and the re-anchor 30 may repeatedly release fixing of the sliding engagement member control part 19 and fix the sliding engagement member control part 19 again a number of times which is not particularly limited.

Therefore, when the base isolator 10 of the present embodiment is used, the horizontal spring 22 may be prevented from being damaged or ruptured even when a greater vibration is generated for a longer period of time.

Further, a depth of a groove provided on a side of the anchored plate 5 is small when compared to the fourth embodiment. For this reason, the elastic body protective structure 21 may be provided even when the anchored plate 5 has an insufficient thickness in the vertically downward direction.

When friction between the second anchoring groove 26 and a second surface 24 is small, each of the fitted portion 35 and the re-fitted portion 31 may not have a spherical shape and may have a cylindrical shape in which only a lower end portion is a downwardly convex spherical shape similarly to the fourth embodiment. In addition, the portion may become thinner in a vertically upward direction and may be inclined.

While certain embodiments have been described, these embodiments have been presented by way of example only, and are not intended to limit the scope of the inventions. Indeed, the novel embodiments described herein may be embodied in a variety of other forms; furthermore, various omissions, substitutions, combination and changes in the form of the embodiments described herein may be made without departing from the spirit of the inventions. The accompanying claims and their equivalents are intended to cover such forms or modifications as would fall within the scope and spirit of the inventions.

For example, the base-isolation unit 12 may not have a rolling base-isolation structure. The base-isolation unit 12 may have a laminated-rubber base-isolation structure in which laminated rubber is used as an elastic body or a sliding base-isolation structure which uses, instead of a rolling support, a sliding support including a smooth surface on which friction with the slide plate 15 is small. Any one of the base-isolation structures is presumed to have an elastic body which reduces horizontal vibrations transmitted from the foundation to the object to be base-isolated by expanding and contracting.

In addition, the base isolator of the present embodiment is effective in base isolation with respect to vibrations generated in the object to be base-isolated 9 due to wind or traffic vibration in addition to vibrations due to an earthquake.

Further, for example, the base isolator of any one of the third embodiment to the fifth embodiment may be provided between a vertical wall and the object to be base-isolated. In this case, the foundation is a foundation provided on the vertical wall or in parallel with the vertical wall. Then, the base isolator may base-isolate the object to be base-isolated from a side surface, thereby preventing damage to the elastic body.

The base isolator according to each embodiment is applicable to an electric counter, a control board, a computer, and the like of major industries such as a nuclear power plant, a thermal power station, and petrochemical plant, and various research facilities, or applicable to a control room, a computer room, and a building equipped with the electric counter, the control board, the computer, and the like.

1. A base isolator provided between an object to be base-isolated and a foundation, the base isolator having an elastic body expanding and contracting to reduce horizontal vibrations generated in the object to be base-isolated, the base isolator comprising:
an anchored portion anchored to the foundation;
a base-isolation unit having the elastic body and provided on the anchored portion;
a first anchoring groove provided on a first surface which is a surface of the base-isolation unit facing the anchored portion;
a second anchoring groove provided on a second surface which is a surface of the anchored portion facing the base-isolation unit; and
an anchor simultaneously fitted into the first anchoring groove and the second anchoring groove such that a horizontal movement of the base-isolation unit with respect to the foundation is restricted,
wherein the anchor removes restriction on the horizontal movement of the base-isolation unit when a predetermined force is applied in a horizontal direction.

2. The base isolator according to claim 1, wherein a horizontal movement of the base-isolation unit with respect to the foundation is restricted again after the restriction on the horizontal movement of the base-isolation unit is removed.

3. The base isolator according to claim 2, further comprising
a re-anchoring groove provided on the second surface,
wherein a re-anchor is provided inside the re-anchoring groove,
the re-anchor has a re-fitted portion and a re-anchor pushing-up portion applying a force to the re-fitted portion in a vertically upward direction, and
the re-fitted portion is allowed to be simultaneously fitted into the first anchoring groove and the re-anchoring groove.

4. The base isolator according to claim 2,
wherein the anchor has a fitted portion and an anchor pushing-up portion applying a force to the fitted portion in a vertically upward direction, and
the fitted portion is allowed to be simultaneously fitted into the first anchoring groove and the second anchoring groove.

5. The base isolator according to claim 3, further comprising
a fractured object falling groove provided on the second surface,
wherein the restriction is removed when at least a part of a portion of the anchor or the re-anchor protruding from the second surface is fractured,
the fractured anchor or re-anchor is allowed to fall into the fractured object falling groove, and the fractured object falling groove is provided between the re-anchoring groove and the second anchoring groove, and
the fractured object falling groove is deeper than a vertical length of the portions of the anchor and the re-anchor protruding from the second surface.

6. The base isolator according to claim 2, further comprising
a re-anchoring groove provided on the second surface,
wherein a re-anchor is provided inside the re-anchoring groove,
the re-anchor has a re-fitted portion and a re-anchor pushing-up portion applying a force to the re-fitted portion in a vertically upward direction,
the re-fitted portion becomes thinner in the vertically upward direction, and is allowed to be simultaneously fitted into the first anchoring groove and the re-fitted groove,
the anchor has a fitted portion and an anchor pushing-up portion applying a force to the fitted portion in a vertically upward direction, and
the fitted portion becomes thinner in the vertically upward direction, and is allowed to be fitted into the first anchoring groove.

7. The base isolator according to claim 6,
wherein vertically upper ends of the re-fitted portion and the fitted portion have upwardly convex spherical shapes, and
the first anchoring groove has a width broadening from an bottom side portion of an opening to the opening.

8. The base isolator according to claim 2, further comprising
a re-anchoring groove provided on the first surface,
wherein a re-anchor is provided inside the re-anchoring groove,
the re-anchor has a re-fitted portion and a re-anchor pushing-down portion applying a force to the re-fitted portion in a vertically downward direction,
the anchor has a fitted portion and an anchor pushing-down portion applying a force to the fitted portion in the vertically downward direction, and
the re-fitted portion and the fitted portion become thinner in the vertically downward direction, and are allowed to be fitted into the second anchoring groove.

9. The base isolator according to claim 8,
wherein vertically lower ends of the re-fitted portion and the fitted portion have downwardly convex spherical shapes, and
the second anchoring groove has a width broadening from an bottom side portion of an opening to the opening.

10. The base isolator according to claim 2, further comprising
a re-anchoring groove provided on the second surface,
wherein the anchor has a shape of a vertically long rod, and
the anchor is allowed to be simultaneously fitted into the re-anchoring groove and the first anchoring groove.
